(19) United States
(12) Patent Application Publication
(10) Pub. No.: US 2006/0088703 A1
(43) Pub. Date: Apr. 27, 2006

(54) Decorative composite plastic mat and method

(75) Inventor: Richard J. Landy, Castaic, CA (US)

Correspondence Address: Harold L. Jackson;Jackson Law Corporation, 14751 Plaza Dr., Ste. N, Tustin, CA, 92780, US

(73) Assignee: Plasticolor Molded Products, Inc.

(21) Appl. No.: 10/972,856

(22) Filed: Oct. 25, 2004

(51) Int. Cl. B32B 3/00

(52) U.S. Cl. 428/204

(57) ABSTRACT

A decorative composite mat includes a top layer of flexible clear thermoplastic material fused to an artwork bearing carrier sheet. A bottom layer, in the form of a flexible plastic sheet, is secured to the bottom of the fused clear plastic/carrier sheet via a strip of trim webbing which extends around the periphery of the mat. The artwork is visible through and protected by the clear plastic top layer.

### FIELD OF THE INVENTION

The present invention relates to flexible plastic mats, such as utility mats, vehicle floor mats, and mud guards, and particularly to such mats which bear decorative artwork.

### BACKGROUND OF THE INVENTION

The term mat, as used herein, shall refer to utility mats, door mats, vehicle floor mats and mud guards or mud flaps. Flexible plastic mats, capable of bearing decorative artwork, are conventionally manufactured in an open face pan mold with the mold being provided with multiple cavities (or recesses). During the molding process the cavities are first filled with a suitably colored, e.g., liquid or pelletized (powdered) plastic materials, e.g., PVC plastisol. The plastisol is heated, e.g., by infra red heat, to form a pre-gel and subsequently the rest of the mold is filled with a suitable background liquid or pelletized plastic material such as a black plastisol. The mold is then passed through an oven where the colored pre-gel artwork is fused with the background material. The entire content of the mold is cured and the finished product removed from the mold.

The definition or resolution of the colored artwork created in this prior art process is limited by the size of the cavities since each cavity will accommodate only a single color. Without the presence of ribs separating the cavities, the individual colors would blend resulting in a non-uniform decoration.

Artwork or graphic designs have also been printed directly on the face of a cured mat. While this technique may result in an enhanced definition or resolution of a detailed design, it suffers from the disadvantage that the surface, bearing the design, is susceptible to wear, especially where the mat is subject to abrasion by a user's shoes, as in the case with floor and utility mats.

The inventor is further aware of a two-piece motorcycle handgrip, as shown by the digital photographs attached to the disclosure statement, in which a black inner plastic sleeve bearing a graphic design has been inserted into (but not bonded to) an outer clear plastic sleeve so that the design is visible through the outer sleeve. Some of the design has been transferred to the outer sleeves as is apparent in the cutaway section of the handgrip. It is not believed that this technique would be amenable to the manufacture of a mat.

There is a need for a decorative mat which overcomes the above disadvantages.

### SUMMARY OF THE INVENTION

A decorative composite mat, in accordance with the present invention, includes a top layer of substantially clear flexible plastic material, such as clear PVC, having a peripheral edge and an inner flexible carrier sheet bonded to the top layer. The carrier sheet bears the desired artwork printed thereon. A bottom layer of flexible plastic material having a peripheral edge coincident with peripheral edge of the top layer is secured to the bottom of the bonded clear plastic layer/carrier sheet to form the composite mat so that the artwork is visible through the clear plastic top layer. Preferably the carrier sheet is integrally molded with the top layer in an injection molding process and the top and bottom layers are secured together via a strip of trim material, such as webbing, which extends over the peripheral edges of the top and bottom layers.

In accordance with the method of manufacturing the above mat, a mold, preferably a two part mold, is provided with a substantially flat back section and a front section so that a cavity is formed between the sections in the closed position. The cavity is sized to conform to the desired periphery and a portion of the depth of the finished mat.

The desired artwork is printed on a carrier sheet which is then placed against the back section of the mold. After the mold is closed a substantially clear thermoplastic material, such as PVC, is injected into the cavity to fuse the material to the carrier sheet forming an integrally molded clear plastic layer/carrier sheet. A flexible plastic backing sheet is then secured to the bottom of the clear plastic layer/carrier sheet preferably via a trim strap extending over the peripheral edges of the top an backing sheets.

The present invention may best be understood by reference to the following description taken in conjunction with the accompanying drawings where like components are given the same reference numeral.

### BRIEF DESCRIPTION OF THE DRAWINGS

FIG. 1 is a top plan view of an automotive floor mat in accordance with the present invention;

FIG. 2 is an exploded unassembled side cross-sectional view showing the three layers of the composite mat of FIG. 1;

FIG. 3 is a side cross-sectional view of an unassembled two-piece mold with a carrier sheet bearing the desired artwork inserted in the mold and illustrating, via arrows, the path of injected thermoplastic material once the mold is closed;

FIG. 4 is a side cross-sectional view of the closed mold of FIG. 3;

FIG. 5 is a plan view of the interior of the front section or die of the mold illustrating the raised protrusions formed in the top layer of the finishing mat;

FIG. 6 is a perspective view of exemplar tooling for manufacturing the plastic bottom layer or backing material; and

FIG. 7 is a diagrammatic illustration of placing a trim strip around the periphery of the assembled top and bottom layers of the mat.

### DESCRIPTION OF THE PREFERRED EMBODIMENT

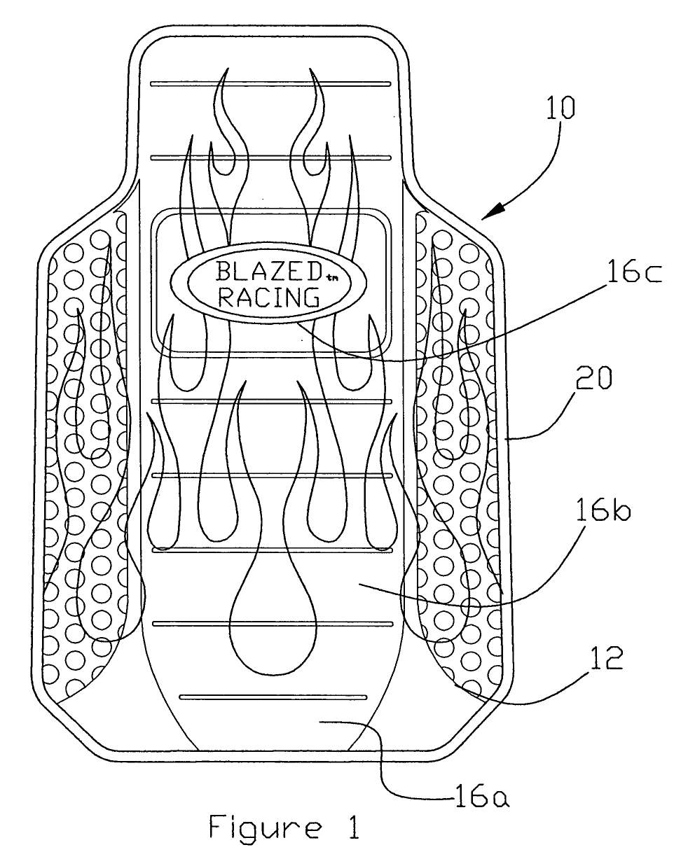

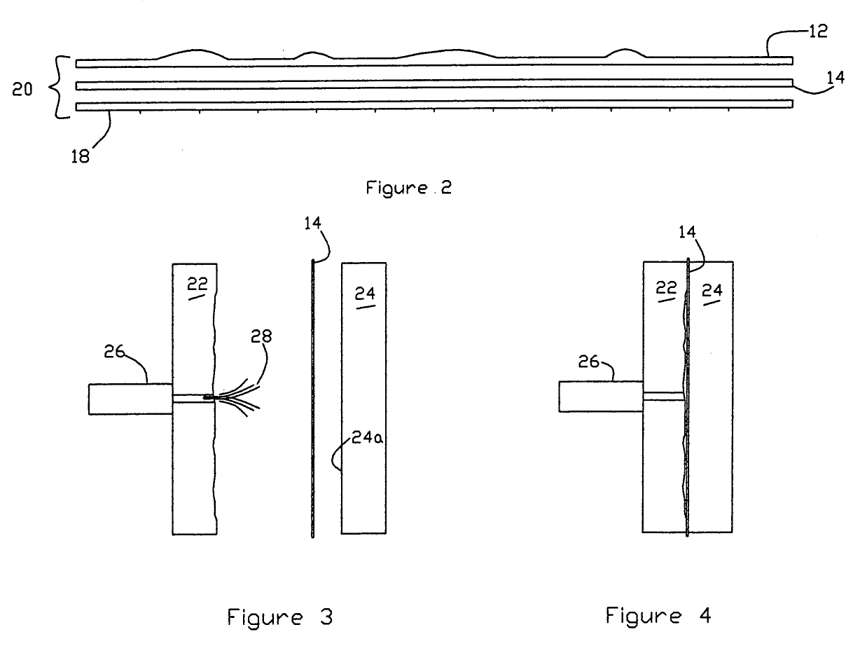

Referring now to FIGS. 1 and 2 a composite mat 10, in the form of a vehicle floor mat, includes a top layer or sheet 12 of substantially clear thermoplastic flexible material, preferably polyvinyl chloride (PVC), which has been fused to an intermediate or inner flexible carrier sheet (layer) 14 bearing the desired design or artwork 16. It should be noted that FIG. 2 illustrates the sheets or layers in an unassembled format for clarity. The carrier sheet may be made of any flexible material such as polyester, cotton, vinyl, etc., capable of bearing the desired artwork and which can be fused via an injection molding process to the clear thermoplastic material. The artwork, while illustrated in black and white, would normally be in color. For example, the artwork shown emulates flames with orange coloration at the lower end 16a merging into red in a central region 16b with blue tips. A brand or trade name is illustrated within the field 16c.

A bottom or base sheet 18, made of a suitable flexible plastic material, of any suitable color such as black, is secured to the bottom of the fused top layer/carrier sheet via a piece of narrow trim webbing 20 which extends over the peripheral edges of the top and bottom sheets and is bound thereto via stitching or other suitable means. See FIG. 7. The term plastic as used to describe the base or bottom layer includes rubber based materials. The overall size and thickness of the mat will vary according to its anticipated use. By way of example only, a vehicle floor mat may be formed with an overall thickness of 3-4 mm, the clear plastic layer accounting for 1/2 to 2/3 of the overall thickness.

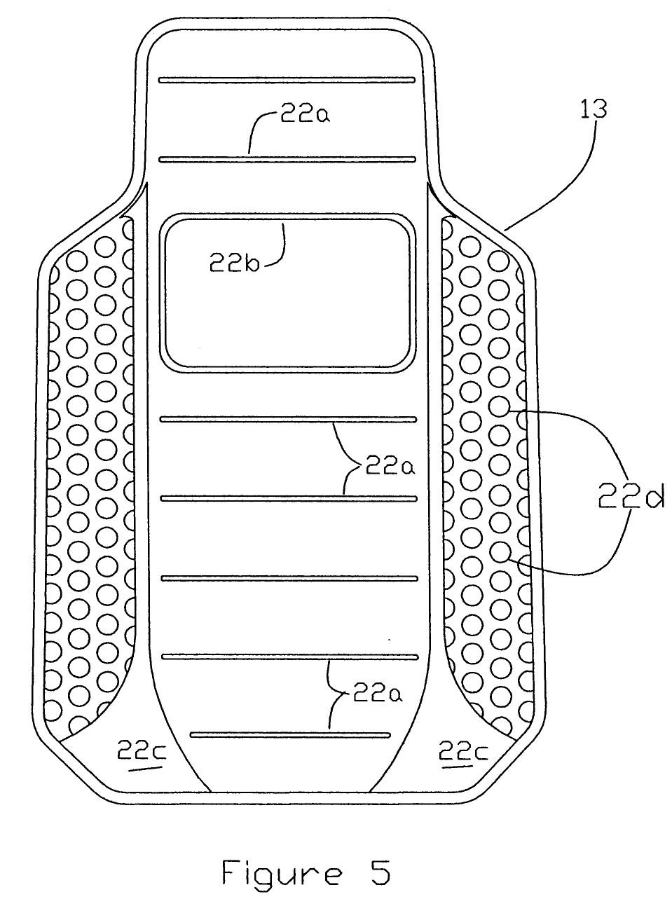

Referring now to FIGS. 3 and 4 a two-part mold for manufacturing the clear plastic top and fused inner carrier sheet includes front section (die) 22 and back section 24 with the back section having a flat surface 24a facing the front section. Conventional clamps (not shown) clamp the sections together in the closed position. The front section 22 is formed with any desired recesses to form decorative and/or functional protrusions on the face of the finished mat. By way of example, the front section of the mold includes lateral recesses 22a, a rectangular border recess 22b, for framing a trademark or the like, longitudinal recesses 22c and dimpled recesses 22d. See. FIG. 5. The protrusions in the finished mat, formed by such recesses, may in addition to being decorative, serve the purpose of providing a shoe traction surface (in a vehicle floor mat) or a shoe scraping surface (on a door mat).

A injection unit 26 injects the clear thermoplastic material into the mold when closed. The path of the injected molten plastic is illustrated by the arrows in FIGS. 3 and 4 although such flow takes place only when the mold is closed, FIG. 4.

In the manufacturing process the carrier sheet 14 is placed against the flat inner surface 24a of the back section 24 (FIG. 3) and then the mold is closed (FIG. 4). Following the injection process, the mold is opened, the fused clear plastic layer/carrier sheet removed and any excess carrier trimmed.

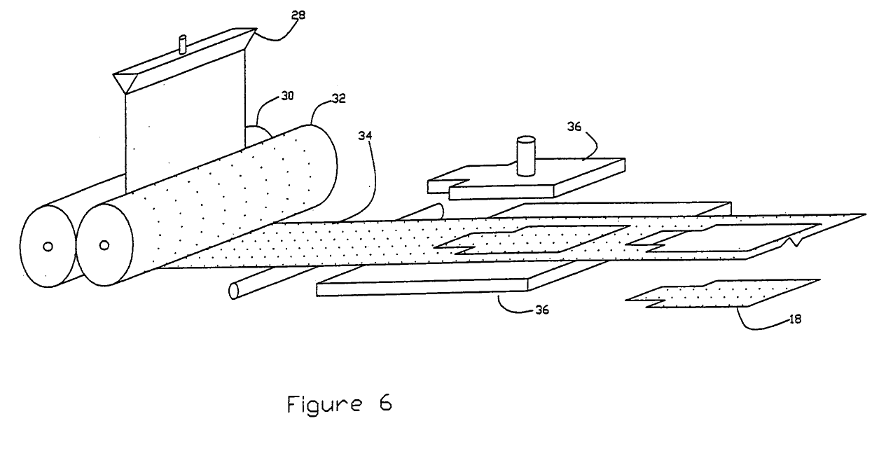

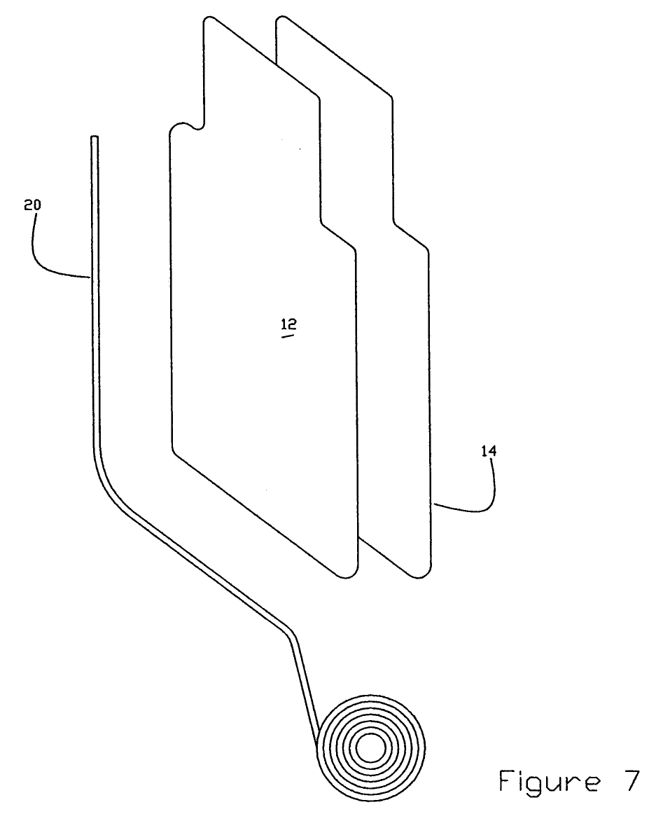

FIG. 6 is illustrative of a method of making the bottom or backing layer in which a web like supply of molten plastic from a supply 28 is fed to roll formers 30 and 32 with the roll 32 having recesses thereon to form a nibbed surface 34 on the mat for gripping a vehicle's floor. A cutting appliance 36 cuts the formed backing strip into a peripheral dimension coincident with the top layer. Alternatively, the backing material may be obtained in roll form and simply cut to the desired shape.

The backing layer is then secured to the bottom of the fused top layer/carrier sheet by the trim webbing 20, as is illustrated in FIG. 7. The printed artwork is rendered visible through the top clear plastic layer and protected by such layer.

There has thus been described a simple and relatively inexpensive novel composite mat and method of making the same which allows high resolution artwork to be displayed on the surface of the mat while protecting such artwork from the wear typically associated with vehicles floor mats, etc. Various modifications of the invention will undoubtedly occur to those skilled in the art without involving a departure from the spirit and scope of my invention as defined by the appended claims.

What is claimed is:

1. A decorative composite mat comprising:
a) a top layer of substantially clear flexible plastic material having a peripheral edge;
b) an inner flexible carrier sheet having the desired artwork printed thereon bonded to the top layer so that the artwork is visible through the top layer;
c) a bottom layer of flexible plastic material having a peripheral edge coincident with the peripheral edge of the top layer; and
d) means for securing the top and bottom layers together with the carrier sheet sandwiched therebetween.

2. The invention of claim 1 wherein the securing means comprises a thin strip of trim material extending over the peripheral edges of the top and bottom layers.

3. The invention of claim 2 wherein the carrier sheet is integrally molded with the top layer.

4. The invention of claim 3 wherein the top layer is formed with decorative and/or functional embossing.

5. The invention of claim 4 wherein the bottom layer is formed with a plurality of downwardly extending surface grasping projections.

6. The invention of claim 5 wherein the top layer comprises clear PVC.

7. The invention of claim 6 wherein the inner layer comprises polyester.

8. The invention of claim 7 wherein the bottom layer comprises a thermoplastic material.

9. The invention of claim 8 wherein the bottom layer is made of rubber.

10. The invention of claim 1 wherein the mat is a vehicle floor mat.

11. The invention of claim 1 wherein the mat is a utility mat.

12. The invention of claim 1 wherein the mat is a mud flap.

13. In a method of manufacturing a decorative composite mat comprising:
a) providing a mold having an open and a closed position, with a substantially flat back section and a front section, the mold in the closed position forming a cavity sized to conform to the desired periphery and a portion of the depth of the finished mat;
b) providing a carrier sheet having desired artwork printed thereon;
c) placing the carrier sheet on the back section of the mold;
d) closing the mold and injecting a substantially clear thermoplastic material into the cavity to fuse a layer of said clear plastic to the carrier sheet and removing the cured clear plastic/carrier sheet from the mold;
e) providing a sheet of plastic backing material having said desired peripheral dimension; and
f) securing the backing sheet to the bottom of the carrier sheet.

14. The method of claim 13 wherein the clear thermoplastic material is PVC.

15. The method of claim 14 wherein the carrier sheet is made of polyester.

16. The method of claim 15 wherein the backing sheet is made of a thermoplastic material.

17. The method of claim 16 wherein the backing material is made of rubber.

18. The method of claim 14 wherein the securing step comprises placing a thin strip of webbing around and over the peripheral edges of the molded clear plastic and backing sheets and stitching the edges of the webbing together.
